(19) United States
(12) Patent Application Publication
(10) Pub. No.: US 2026/0213532 A1
(43) Pub. Date: Jul. 23, 2026

(54) SYSTEM AND METHOD FOR PROVIDING SPEED DEPENDENT GRID FREQUENCY SUPPORT IN GRID-FORMING INVERTER-BASED RESOURCES

(71) Applicant: General Electric Renovables España, S.L., Barcelona (ES)

(72) Inventors: Dustin F. Howard, Brookhaven, GA (US); Leonardo Cesar Kammer, Niskayuna, NY (US); Cornelius Edward Holliday, III, Forest, VA (US); Vaidhya Nath Venkitanarayanan, Schenectady, NY (US)

(21) Appl. No.: 19/124,086

(22) PCT Filed: Oct. 28, 2022
(86) PCT No.: PCT/US2022/048143

§ 371 Date: Apr. 24, 2025

(51) Int. Cl. H02J 3/001; H02J 3/02; H02J 3/38; H02J 101/28; H02K 7/18; H02P 9/10

(52) U.S. Cl. CPC H02J 3/001; H02J 3/02; H02J 3/381; H02K 7/183; H02P 9/107; H02J 2101/28

(57) ABSTRACT

A method for constraining grid frequency support of a wind turbine connected to an electrical grid to prevent a trip event in the wind turbine includes receiving, via a controller, one or more speed feedback signals from the wind turbine. Further, the method also includes adjusting, via the controller, one or more parameters of a power regulator of the wind turbine based on the one or more speed feedback signals such that a power output of the wind turbine is less sensitive to changes in at least one of grid frequency or phase angle.

### FIELD

The present disclosure relates generally to wind turbines and, more particularly, to systems and methods for providing speed dependent grid frequency support in grid-forming wind turbines.

### BACKGROUND

Wind power is considered one of the cleanest, most environmentally friendly energy sources presently available, and wind turbines have gained increased attention in this regard. A modern wind turbine typically includes a tower, generator, gearbox, nacelle, and one or more rotor blades. The rotor blades capture kinetic energy of wind using known airfoil principles. For example, rotor blades typically have the cross-sectional profile of an airfoil such that, during operation, air flows over the blade producing a pressure difference between the sides. Consequently, a lift force, which is directed from a pressure side towards a suction side, acts on the blade. The lift force generates torque on the main rotor shaft, which is typically geared to a generator for producing electricity.

Wind turbines can be distinguished in two types: fixed speed and variable speed turbines. Conventionally, variable speed wind turbines are controlled as current sources connected to a power grid. In other words, the variable speed wind turbines rely on a grid frequency detected by a phase locked loop (PLL) as a reference and inject a specified amount of current into the grid. The conventional current source control of the wind turbines is based on the assumptions that the grid voltage waveforms are fundamental voltage waveforms with fixed frequency and magnitude and that the penetration of wind power into the grid is low enough so as to not cause disturbances to the grid voltage magnitude and frequency. Thus, the wind turbines simply inject the specified current into the grid based on the fundamental voltage waveforms. However, with the rapid growth of the wind power, wind power penetration into some grids has increased to the point where wind turbine generators have a significant impact on the grid voltage and frequency. When wind turbines are located in a weak grid, wind turbine power fluctuations may lead to an increase in magnitude and frequency variations in the grid voltage. These fluctuations may adversely affect the performance and stability of the PLL and wind turbine current control.

Furthermore, many existing renewable generation converters, such as double-fed wind turbine generators, operate in a “grid-following” mode. Grid-following type devices utilize fast current-regulation loops to control active and reactive power exchanged with the grid. More specifically, FIG. 1 illustrates the basic elements of the main circuit and converter control structure for a grid-following double-fed wind turbine generator. As shown, the active power reference to the converter is developed by the energy source regulator, e.g., the turbine control portion of a wind turbine. This is conveyed as a torque reference which represents the lesser of the maximum attainable power from the energy source at that instant, or a curtailment command from a higher-level grid controller. The converter control then determines a current reference for the active component of current to achieve the desired torque. Accordingly, the double-fed wind turbine generator includes functions that manage the voltage and reactive power in a manner that results in a command for the reactive component of current. Wide-bandwidth current regulators then develop commands for voltage to be applied by the converters to the system, such that the actual currents closely track the commands.

Alternatively, grid-forming type converters provide a voltage-source characteristic, where the angle and magnitude of the voltage are controlled to achieve the regulation functions needed by the grid. With this structure, current will flow according to the demands of the grid while the converter contributes to establishing a voltage and frequency for the grid. This characteristic is comparable to conventional generators based on a turbine driving a synchronous machine. Thus, a grid-forming source must include the following basic functions: (1) support grid voltage and frequency for any current flow within the rating of the equipment, both real and reactive; (2) prevent operation beyond equipment voltage or current capability by allowing grid voltage or frequency to change rather than disconnecting equipment (disconnection is allowed only when voltage or frequency are outside of bounds established by the grid entity); (3) remain stable for any grid configuration or load characteristic, including serving an isolated load or connected with other grid-forming sources, and switching between such configurations; (4) share total load of the grid among other grid-forming sources connected to the grid; (5) ride through grid disturbances, both major and minor, and (6) meet requirements (1)-(5) without requiring fast communication with other control systems existing in the grid, or externally-created logic signals related to grid configuration changes.

The basic control structure to achieve the above grid-forming objectives was developed and field-proven for battery systems in the early 1990's (see e.g., U.S. Pat. No.: 5,798,633 entitled “Battery Energy Storage Power Conditioning System”). Applications to full-converter wind generators and solar generators are disclosed in United States Publication No.: 2010/0142237 entitled “System and Method for Control of a Grid Connected Power Generating System,” and U.S. Pat. No.: 9,270,194 entitled “Controller for controlling a power converter.” However, such implementations have been employed on full-converter wind generators.

Grid-forming wind turbine generators enhance grid stability by changing their power output automatically in response to grid frequency and phase changes. The capability of wind turbines to supply this support can be limited, however, based on the operating point of the wind turbine. For example, at low rotor speeds in which the wind turbine is operating close to its lower speed limit, small grid-induced power increases can cause the speed to drop enough to cause an under-speed trip.

In view of the foregoing, a system and method that addresses the aforementioned issues would be welcomed in the art. Accordingly, the present disclosure is directed to a system and method for constraining grid frequency support when the wind turbine does not have sufficient kinetic energy or energy input from the wind to avoid these grid-induced under-speed trips while retaining grid-forming characteristics of the wind turbine.

### BRIEF DESCRIPTION

Aspects and advantages of the invention will be set forth in part in the following description, or may be obvious from the description, or may be learned through practice of the invention.

The present disclosure is directed to a method for constraining grid frequency support of a wind turbine connected to an electrical grid to prevent a trip event in the wind turbine. The method includes receiving, via a controller, one or more speed feedback signals from the wind turbine. Further, the method includes adjusting, via the controller, one or more parameters of a power regulator of the wind turbine based on the one or more speed feedback signals such that a power output of the wind turbine is less sensitive to changes in at least one of grid frequency or phase angle.

In another aspect, the present disclosure is directed to power regulator configured to constrain grid frequency support of a wind turbine connected to an electrical grid to prevent a trip event in the wind turbine. The power regulator includes a controller including at least one processor. The processor(s) is configured to perform a plurality of operations, including but not limited to receiving one or more speed feedback signals from the wind turbine and adjusting one or more parameters of a power regulator of the wind turbine based on the one or more speed feedback signals such that a power output of the wind turbine is less sensitive to changes in at least one of grid frequency or phase angle.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a one-line diagram of a double-fed wind turbine generator with structure of converter controls for grid-following application according to conventional construction;

FIG. 2 illustrates a perspective view of one embodiment of a wind turbine according to the present disclosure;

FIG. 3 illustrates a simplified, internal view of one embodiment of a nacelle according to the present disclosure;

FIG. 4 illustrates a schematic view of one embodiment of a wind turbine electrical power system suitable for use with the wind turbine shown in FIG. 1;

FIG. 5 illustrates a schematic view of another embodiment of a wind turbine electrical power system suitable for use with the wind turbine shown in FIG. 1;

FIG. 6 illustrates a schematic view of one embodiment of a wind farm having a plurality of wind turbines according to the present disclosure;

FIG. 7 illustrates a block diagram of one embodiment of a controller according to the present disclosure;

FIG. 8 illustrates a one-line diagram of a double-fed wind turbine generator with converter controls for grid-forming application according to the present disclosure;

FIG. 9 illustrates a detailed, block diagram of an embodiment of a power regulator according to the present disclosure;

FIG. 10 illustrates a flow diagram of an embodiment of a method for constraining grid frequency support of a wind turbine connected to an electrical grid to prevent a trip event in the wind turbine according to the present disclosure; and

FIG. 11 illustrates a schematic diagram of an embodiment of a system for adjusting one or more gains of a power regulator of a wind turbine based on speed such that a power output of the wind turbine is less sensitive to changes in the grid frequency and/or the phase angle according to the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Grid-forming wind turbine generators enhance grid stability by changing their power output automatically in response to grid frequency and phase changes. The capability of wind turbines to supply this support can be limited, however, based on the operating point of the wind turbine. For example, at low rotor speeds in which the wind turbine is operating near its lower speed limit, small grid induced power increases can cause the speed to drop enough to cause an under-speed trip. Therefore, the systems and methods of the present disclosure are directed to constraining grid frequency support when the wind turbine does not have sufficient kinetic energy to avoid these grid-induced under-speed trips.

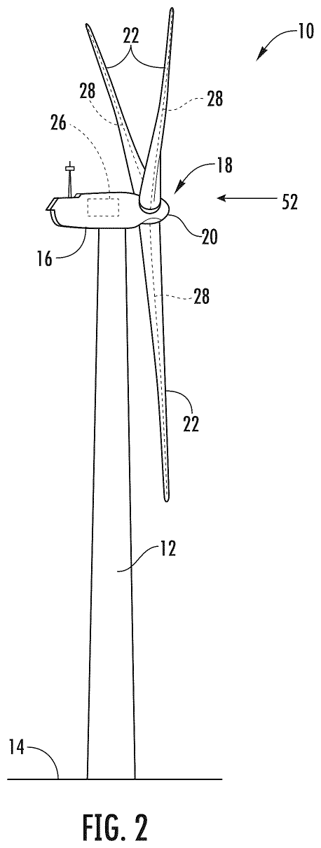

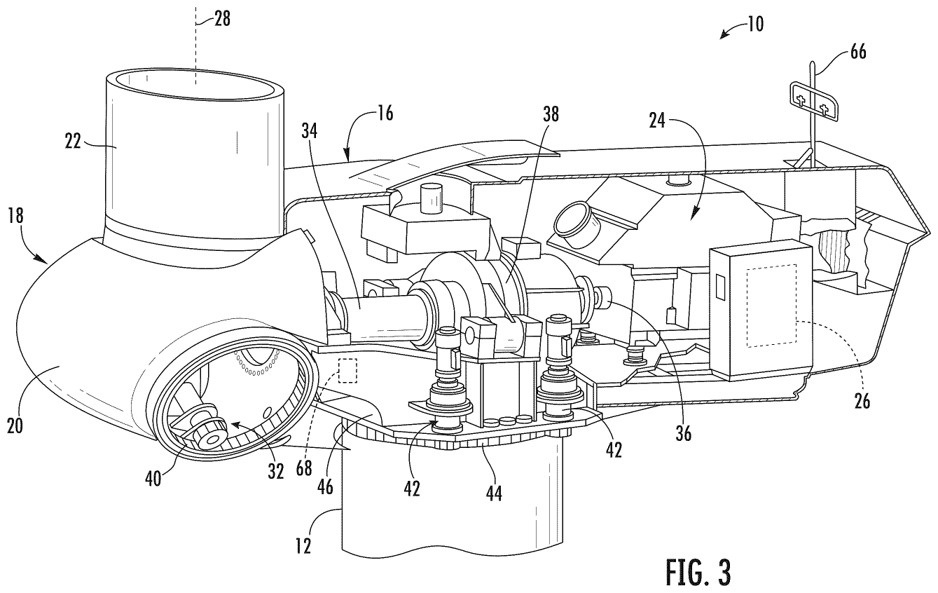

Referring now to the drawings, FIG. 2 illustrates a perspective view of one embodiment of a wind turbine 10 according to the present disclosure. As shown, the wind turbine 10 generally includes a tower 12 extending from a support surface 14, a nacelle 16 mounted on the tower 12, and a rotor 18 coupled to the nacelle 16. The rotor 18 includes a rotatable hub 20 and at least one rotor blade 22 coupled to and extending outwardly from the hub 20. For example, in the illustrated embodiment, the rotor 18 includes three rotor blades 22. However, in an alternative embodiment, the rotor 18 may include more or less than three rotor blades 22. Each rotor blade 22 may be spaced about the hub 20 to facilitate rotating the rotor 18 to enable kinetic energy to be transferred from the wind into usable mechanical energy, and subsequently, electrical energy. For instance, the hub 20 may be rotatably coupled to an electric generator 24 (FIG. 3) positioned within the nacelle 16 to permit electrical energy to be produced.

The wind turbine 10 may also include a wind turbine controller 26 centralized within the nacelle 16. However, in other embodiments, the controller 26 may be located within any other component of the wind turbine 10 or at a location outside the wind turbine 10. Further, the controller 26 may be communicatively coupled to any number of the components of the wind turbine 10 in order to control the operation of such components and/or implement a corrective or control action. As such, the controller 26 may include a computer or other suitable processing unit. Thus, in several embodiments, the controller 26 may include suitable computer-readable instructions that, when implemented, configure the controller 26 to perform various different functions, such as receiving, transmitting and/or executing wind turbine control signals. Accordingly, the controller 26 may generally be configured to control the various operating modes (e.g., start-up or shut-down sequences), de-rating or up-rating the wind turbine, and/or individual components of the wind turbine 10.

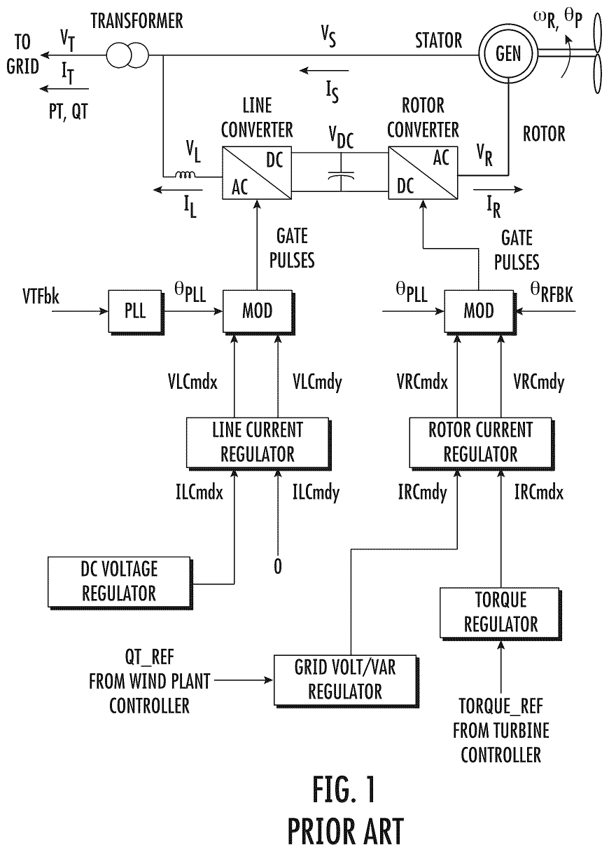

Referring now to FIG. 2, a simplified, internal view of one embodiment of the nacelle 16 of the wind turbine 10 shown in FIG. 1 is illustrated. As shown, a generator 24 may be disposed within the nacelle 16 and supported atop a bedplate 46. In general, the generator 24 may be coupled to the rotor 18 for producing electrical power from the rotational energy generated by the rotor 18. For example, as shown in the illustrated embodiment, the rotor 18 may include a rotor shaft 34 coupled to the hub 20 for rotation therewith. The rotor shaft 34 may, in turn, be rotatably coupled to a generator shaft 36 of the generator 24 through a gearbox 38. As is generally understood, the rotor shaft 34 may provide a low speed, high torque input to the gearbox 38 in response to rotation of the rotor blades 22 and the hub 20. The gearbox 38 may then be configured to convert the low speed, high torque input to a high speed, low torque output to drive the generator shaft 36 and, thus, the generator 24.

The wind turbine 10 may also one or more pitch drive mechanisms 32 communicatively coupled to the wind turbine controller 26, with each pitch adjustment mechanism(s) 32 being configured to rotate a pitch bearing 40 and thus the individual rotor blade(s) 22 about its respective pitch axis 28. In addition, as shown, the wind turbine 10 may include one or more yaw drive mechanisms 42 configured to change the angle of the nacelle 16 relative to the wind (e.g., by engaging a yaw bearing 44 of the wind turbine 10 that is arranged between the nacelle 16 and the tower 12 of the wind turbine 10).

In addition, the wind turbine 10 may also include one or more sensors 66, 68 for monitoring various wind conditions of the wind turbine 10. For example, the incoming wind direction 52, wind speed, or any other suitable wind condition near of the wind turbine 10 may be measured, such as through use of a suitable weather sensor 66. Suitable weather sensors may include, for example, Light Detection and Ranging (“LIDAR”) devices, Sonic Detection and Ranging (“SODAR”) devices, anemometers, wind vanes, barometers, radar devices (such as Doppler radar devices) or any other sensing device which can provide wind directional information now known or later developed in the art. Still further sensors 68 may be utilized to measure additional operating parameters of the wind turbine 10, such as voltage, current, vibration, etc. as described herein.

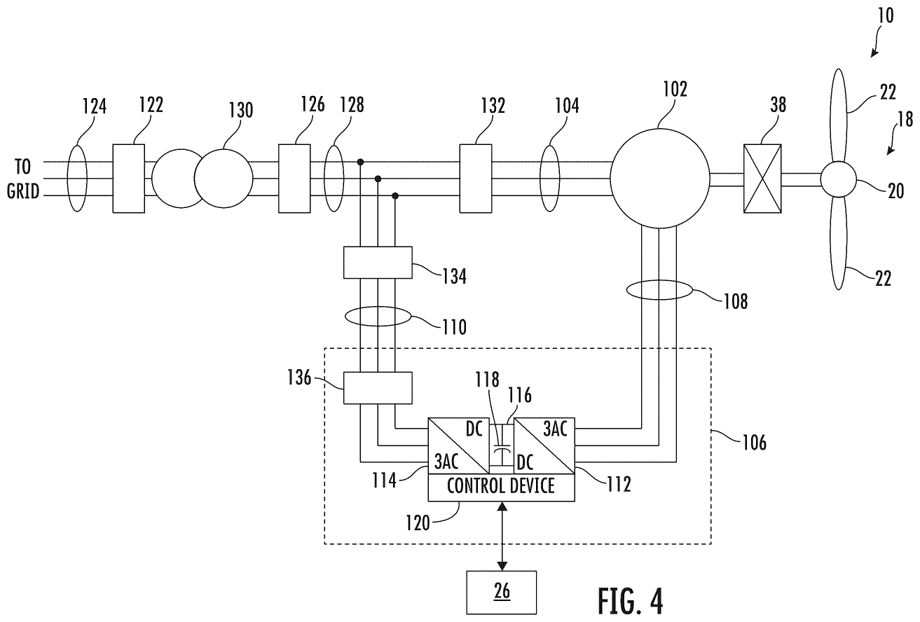

Referring now to FIG. 4, a schematic diagram of one embodiment of a wind turbine power system 100 is illustrated in accordance with aspects of the present disclosure. Although the present disclosure will generally be described herein with reference to the system 100 shown in FIG. 4, those of ordinary skill in the art, using the disclosures provided herein, should understand that aspects of the present disclosure may also be applicable in other power generation systems, and, as mentioned above, that the invention is not limited to wind turbine systems.

In the embodiment of FIG. 4 and as mentioned, the rotor 18 of the wind turbine 10 (FIG. 2) may, optionally, be coupled to the gearbox 38, which is, in turn, coupled to a generator 102, which may be a doubly fed induction generator (DFIG). As shown in FIG. 4, the generator 102 may be connected to a stator bus 104. Further, as shown, a power converter 106 may be connected to the generator 102 via a rotor bus 108, and to the stator bus 104 via a line side bus 110. As such, the stator bus 104 may provide an output multiphase power (e.g., three-phase power) from a stator of the generator 102, and the rotor bus 108 may provide an output multiphase power (e.g., three-phase power) from a rotor of the generator 102. The power converter 106 may also include a rotor side converter (RSC) 112 and a line side converter (LSC) 114. The generator 102 is coupled via the rotor bus 108 to the rotor side converter 112. Additionally, the RSC 112 is coupled to the LSC 114 via a DC link 116 across which is a DC link capacitor 118. The LSC 114 is, in turn, coupled to the line side bus 110.

The RSC 112 and the LSC 114 may be configured for normal operating mode in a three-phase, pulse width modulation (PWM) arrangement using one or more switching devices, such as insulated gate bipolar transistor (IGBT) switching elements. In addition, the power converter 106 may be coupled to a converter controller 120 in order to control the operation of the rotor side converter 112 and/or the line side converter 114 as described herein. It should be noted that the converter controller 120 may be configured as an interface between the power converter 106 and the turbine controller 26 and may include any number of control devices.

In typical configurations, various line contactors and circuit breakers including, for example, a grid breaker 122 may also be included for isolating the various components as necessary for normal operation of the generator 102 during connection to and disconnection from a load, such as the electrical grid 124. For example, a system circuit breaker 126 may couple a system bus 128 to a transformer 130, which may be coupled to the electrical grid 124 via the grid breaker 122. In alternative embodiments, fuses may replace some or all of the circuit breakers.

In operation, alternating current power generated at the generator 102 by rotating the rotor 18 is provided to the electrical grid 124 via dual paths defined by the stator bus 104 and the rotor bus 108. On the rotor bus side 108, sinusoidal multi-phase (e.g., three-phase) alternating current (AC) power is provided to the power converter 106. The rotor side converter 112 converts the AC power provided from the rotor bus 108 into direct current (DC) power and provides the DC power to the DC link 116. As is generally understood, switching elements (e.g., IGBTs) used in the bridge circuits of the rotor side converter 112 may be modulated to convert the AC power provided from the rotor bus 108 into DC power suitable for the DC link 116.

In addition, the line side converter 114 converts the DC power on the DC link 116 into AC output power suitable for the electrical grid 124. In particular, switching elements (e.g., IGBTs) used in bridge circuits of the line side converter 114 can be modulated to convert the DC power on the DC link 116 into AC power on the line side bus 110. The AC power from the power converter 106 can be combined with the power from the stator of generator 102 to provide multi-phase power (e.g., three-phase power) having a frequency maintained substantially at the frequency of the electrical grid 124 (e.g., 50 Hz or 60 Hz).

Additionally, various circuit breakers and switches, such as grid breaker 122, system circuit breaker 126, stator sync switch 132, converter breaker 134, and line contactor 136 may be included in the wind turbine power system 100 to connect or disconnect corresponding buses, for example, when current flow is excessive and may damage components of the wind turbine power system 100 or for other operational considerations. Additional protection components may also be included in the wind turbine power system 100.

Moreover, the power converter 106 may receive control signals from, for instance, the local control system 176 via the converter controller 120. The control signals may be based, among other things, on sensed states or operating characteristics of the wind turbine power system 100. Typically, the control signals provide for control of the operation of the power converter 106. For example, feedback in the form of a sensed speed of the generator 102 may be used to control the conversion of the output power from the rotor bus 108 to maintain a proper and balanced multi-phase (e.g., three-phase) power supply. Other feedback from other sensors may also be used by the controller(s) 120, 26 to control the power converter 106, including, for example, stator and rotor bus voltages and current feedbacks. Using the various forms of feedback information, switching control signals (e.g., gate timing commands for IGBTs), stator synchronizing control signals, and circuit breaker signals may be generated.

The power converter 106 also compensates or adjusts the frequency of the three-phase power from the rotor for changes, for example, in the wind speed at the hub 20 and the rotor blades 22. Therefore, mechanical and electrical rotor frequencies are decoupled and the electrical stator and rotor frequency matching is facilitated substantially independently of the mechanical rotor speed.

Under some states, the bi-directional characteristics of the power converter 106, and specifically, the bi-directional characteristics of the LSC 114 and RSC 112, facilitate feeding back at least some of the generated electrical power into generator rotor. More specifically, electrical power may be transmitted from the stator bus 104 to the line side bus 110 and subsequently through the line contactor 136 and into the power converter 106, specifically the LSC 114 which acts as a rectifier and rectifies the sinusoidal, three-phase AC power to DC power. The DC power is transmitted into the DC link 116. The capacitor 118 facilitates mitigating DC link voltage amplitude variations by facilitating mitigation of a DC ripple sometimes associated with three-phase AC rectification.

The DC power is subsequently transmitted to the RSC 112 that converts the DC electrical power to a three-phase, sinusoidal AC electrical power by adjusting voltages, currents, and frequencies. This conversion is monitored and controlled via the converter controller 120. The converted AC power is transmitted from the RSC 112 via the rotor bus 108 to the generator rotor. In this manner, generator reactive power control is facilitated by controlling rotor current and voltage.

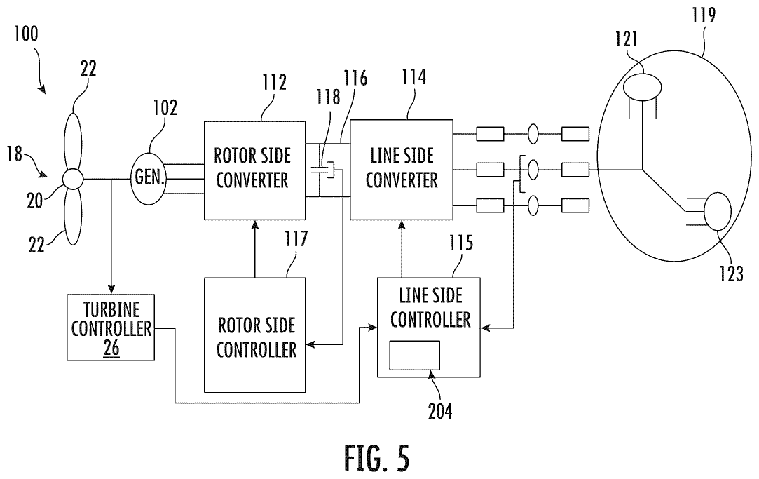

Referring now to FIG. 5, a schematic diagram of one embodiment of another wind turbine power system 100 is illustrated in accordance with aspects of the present disclosure. In particular, FIG. 5 illustrates a full-power conversion system. It should be understood that similar components of FIG. 5 will have the same numbering as set forth in FIG. 4. Furthermore, as shown, the wind turbine power system 100 includes the generator 102, the rotor side converter 112, and the line side converter 114. The wind turbine power system 100 may further include a grid side controller 115, a line side controller 117, and a power grid 119. In an embodiment, the generator 102 may include a squirrel cage induction generator, a synchronous generator, or a permanent magnet synchronous generator. Moreover, as shown, the power grid 119 may include traditional synchronous generators 121 and electrical loads 123.

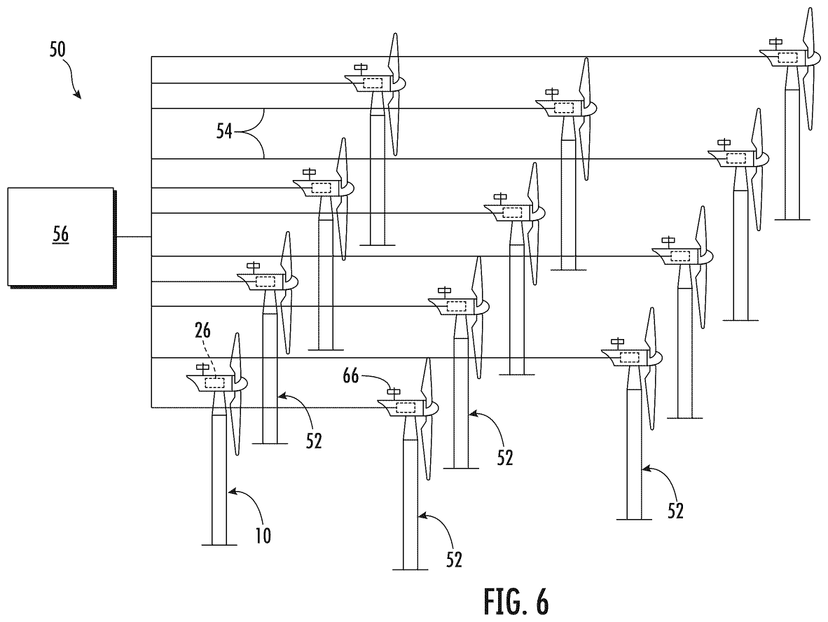

Referring now to FIG. 6, the wind turbine power system 100 described herein may be part of a wind farm 50. As shown, the wind farm 50 may include a plurality of wind turbines 52, including the wind turbine 10 described above, and an overall farm-level controller 56. For example, as shown in the illustrated embodiment, the wind farm 50 includes twelve wind turbines, including wind turbine 10. However, in other embodiments, the wind farm 50 may include any other number of wind turbines, such as less than twelve wind turbines or greater than twelve wind turbines. In one embodiment, the turbine controllers of the plurality of wind turbines 52 are communicatively coupled to the farm-level controller 56, e.g., through a wired connection, such as by connecting the turbine controller 26 through suitable communicative links 54 (e.g., a suitable cable). Alternatively, the turbine controllers may be communicatively coupled to the farm-level controller 56 through a wireless connection, such as by using any suitable wireless communications protocol known in the art. In further embodiments, the farm-level controller 56 is configured to send and receive control signals to and from the various wind turbines 52, such as for example, distributing real and/or reactive power demands across the wind turbines 52 of the wind farm 50.

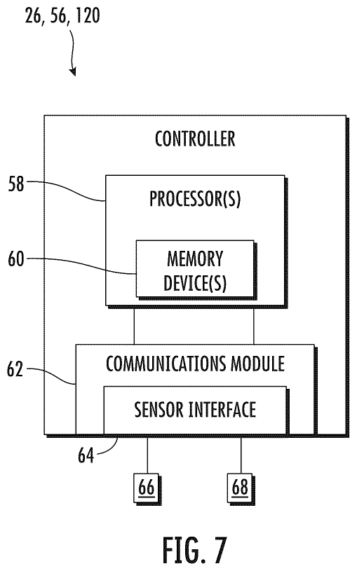

Referring now to FIG. 7, a block diagram of one embodiment of suitable components that may be included within the controller (such as any one of the converter controller 120, the turbine controller 26, and/or the farm-level controller 56 described herein) in accordance with example aspects of the present disclosure is illustrated. As shown, the controller may include one or more processor(s) 58, computer, or other suitable processing unit and associated memory device(s) 60 that may include suitable computer-readable instructions that, when implemented, configure the controller to perform various different functions, such as receiving, transmitting and/or executing wind turbine control signals (e.g., performing the methods, steps, calculations and the like disclosed herein).

As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 60 may generally comprise memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements.

Such memory device(s) 60 may generally be configured to store suitable computer-readable instructions that, when implemented by the processor(s) 58, configure the controller to perform various functions as described herein. Additionally, the controller may also include a communications interface 62 to facilitate communications between the controller and the various components of the wind turbine 10. An interface can include one or more circuits, terminals, pins, contacts, conductors, or other components for sending and receiving control signals. Moreover, the controller may include a sensor interface 64 (e.g., one or more analog-to-digital converters) to permit signals transmitted from the sensors 66, 68 to be converted into signals that can be understood and processed by the processor(s) 58.

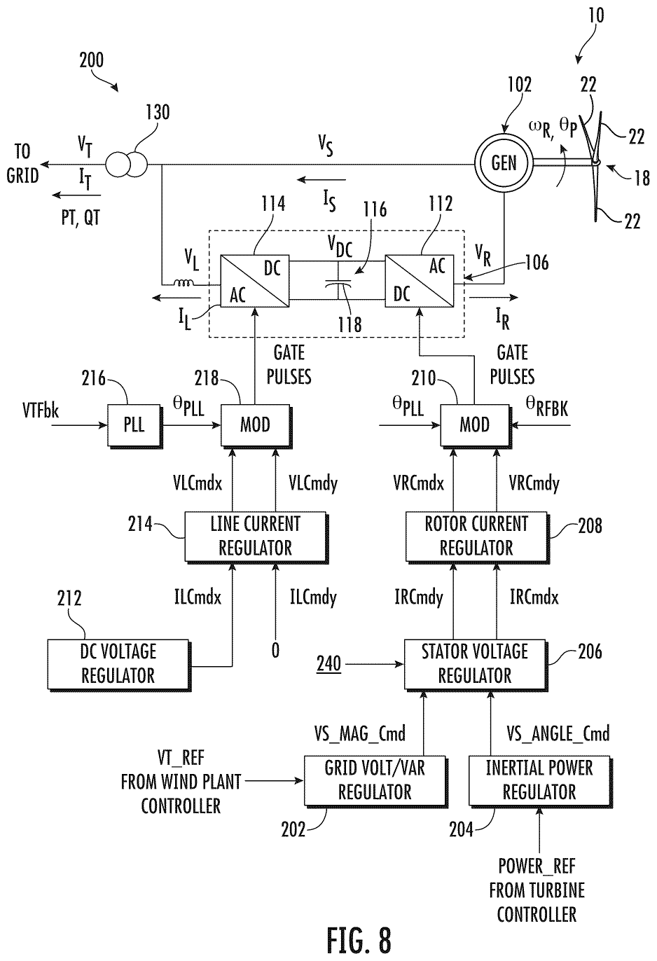

Referring now to FIG. 8, a schematic diagram of an embodiment of a grid forming power system 200 according to the present disclosure, particularly illustrating a one-line diagram of the double-fed wind turbine generator 102 with a high-level control structure for grid-forming characteristics. In particular, as shown, the grid forming power system 200 may include many of the same features of FIG. 4 described herein, with components having the same reference characters representing like components. Further, as shown, the grid forming power system 200 may include a control structure for controlling the line side converter that is similar to the control structure shown in FIG. 1. More particularly, as shown, the line side converter control structure may include a DC regulator 212 and a line current regulator 214. The DC regulator 212 is configured to generate line-side current commands for the line current regulator 214. The line current regulator 214 then generates line-side voltage commands for a modulator 218. The modulator 218 also receives an output (e.g., a phase-locked loop angle) from a phase-locked loop 216 to generate one or more gate pulses for the line side converter 114. The phase-locked loop 216 typically generates its output using a voltage feedback signal.

Furthermore, as shown, the grid forming power system 200 may also include a unique control structure for controlling the rotor side converter 112 using grid-forming characteristics. In particular, as shown in FIG. 8, the grid forming power system 200 may include a stator voltage regulator 206 for providing such grid-forming characteristics. In addition, as shown, the grid forming power system 200 may include a grid voltage/VAR regulator 202, an inertial power regulator 204, a rotor current regulator 208, and a modulator 210.

More particularly, as will be explained, the grid forming power system 200 includes an inner-loop current-regulator structure and a fast stator voltage regulator to convert voltage commands from the grid-forming controls to rotor current regulator commands. Thus, the system and method of the present disclosure provide control of the rotor voltage of the generator 102 to meet a higher-level command for magnitude and angle of stator voltage. Such control must be relatively fast and insensitive to current flowing in the stator of the double-fed wind turbine generator 102.

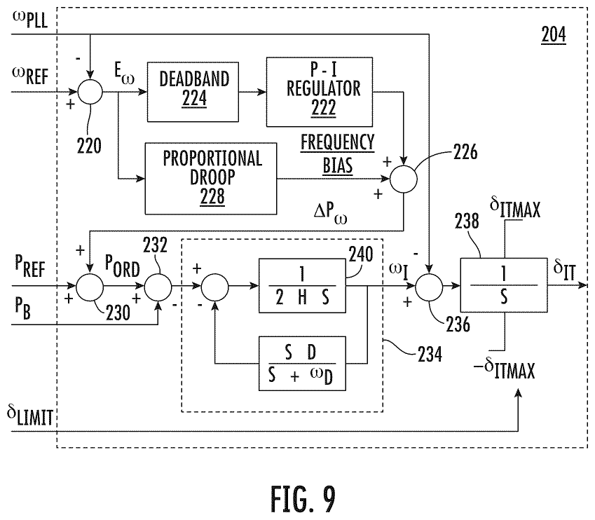

Referring now to FIG. 9, a detailed, block diagram of a power regulator, such as the power regulator 204, is illustrated according to the present disclosure. In particular, as shown, the power regulator 205 includes a frequency reference signal WREF and a phase lock loop frequency signal ω_{PLL} being combined to generate a frequency error signal E_{ω}is illustrated according to the present disclosure. In particular embodiments, for example, the power regulator 204 may be a grid forming power regulator.

As shown, the ω_{PLL} signal, which represents the actual frequency of the output of the inverter-based resource, is subtracted from the ω_{REF} signal in a summing junction 220 to generate the E_{ω}error signal. The error signal E_{ω}is provided to a frequency bias control having a first control loop including a conventional proportional plus integral regulator 222 and a deadband control 224. The deadband control 224 provides some range of variation of the frequency error signal, for example, approximately ½ Hz without any change of output signal. This limits response due to natural fluctuations of the power system frequency. The proportional plus integral regulator 222 converts the error signal E_{ω}to a conventional bias signal, which is applied to a summing junction 226.

A second loop includes a proportional droop control 228, which may be a fixed gain that receives the error signal E_{ω}and provides an immediate compensation signal to the summing junction 76, the compensation signal being added to the output signal from the proportional plus integral regulator 222. The output of the summing junction 226 is a power offset signal which is coupled to a summing junction 230 whose other input is the power reference signal PREF. Accordingly, the frequency offset signal from summing junction 226 serves to modify the power reference signal. The purpose of such modification is to adjust the power reference signal as a function of frequency shifts. More particularly, the intent of the system is to attempt to hold the system output frequency constant so that if there is an error between the output frequency and the reference frequency, the power reference signal is adjusted to compensate for the frequency error. Still further, the power system to which the inverter-based resource is coupled may include reactive loads such as alternating current induction and synchronous motors whose speed is directly related to the frequency of the inverter output signal. If additional power is supplied from the inverter-based resource, the inverter-based resource will tend to accelerate while a reduction in power will cause the frequency to drop due to the inductive reaction of the machines as they begin to slow down. Accordingly, the frequency bias control provides an important function in enabling control of the torque output of the machines coupled to the output of the inverter-based resource. When parallel grid forming resources are connected in a wind farm, the droop (or frequency bias control) also facilitates sharing of active power among the parallel resources.

The power regulator 204 also introduces an inertial regulator 234 which modifies the power error signal to simulate the inertia of synchronous machines. More particularly, the inertial regulator 234 prevents sudden frequency changes or power changes which can cause transient torques to be generated by the motors coupled to the output of the inverter-based resource if sudden changes in the output are experienced.

If the power reference signal is modified by the frequency bias control, the resultant signal identified as P_{ORD} is developed at an output terminal of the summing junction 230 and applied to a summing junction 232 where the commanded power or ordered power is compared to the measured output power PB of the system. In such embodiments, the PB signal represents the real power developed at the output of the inverter-based resource. The output signal from the summation junction 232 represents the power error signal which is applied to the inertial regulator 234. The signal developed by the inertial regulator 234 as described above represents the desired frequency ω₁ of the internal voltage E₁ and, if the frequency is properly tracking, will be the same as the frequency ω_{PLL}.

In this regard, the signal ω₁ developed at the output of the inertial regulator 234 is summed in a summing junction 236 with the ω_{PLL} signal. Any difference between the phase lock loop frequency and the signal ω₁ results in an error signal which is applied to an integrator 238 to develop the δ_{IT} signal. In an embodiment, the integrator 238 is a conventional type of integrator whose output signal δIT is an angle offset which can be summed with the output signal from the phase lock loop to generate the output signal θ₁. It will be recognized that the ω_{PLL} signal is taken from the phase lock loop and therefore represents the actual frequency of the output of the inverter-based resource. In the event that the utility breaker opens suddenly, the ω_{PLL} signal will represent the actual frequency of the voltage being generated by the inverter-based resource and the power regulator 204 will cause the power output of the inverter-based resource to be adjusted as a function of the variation in output frequency. An integrator 240 in the inertial regulator 234 becomes important to limit any attempted frequency change in the control system. It will be recognized that the settings of the deadband control 224, the gain at the proportional droop control 228 are selected to coordinate with the variations of the power system to which the inverter-based resource is connected and also with the loads to which the inverter-based resource is to supply power. Furthermore, the grid forming power system 200 can be adapted to modify the settings of the deadband control 224, the proportional droop control 228, and/or the inertial power regulator 204 in an adaptive manner such as when the status of the utility breaker is changed, either to connect the utility to the system or to disconnect the utility from the load system.

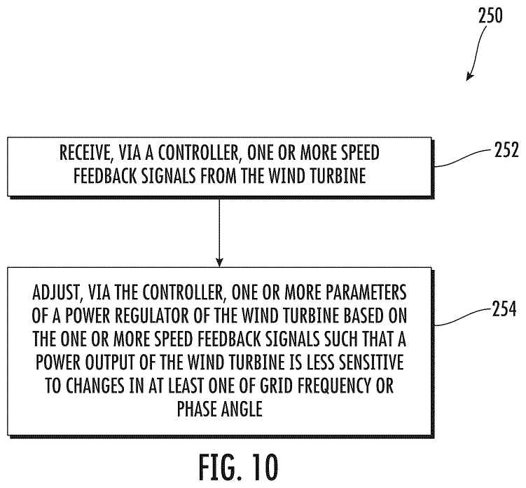

In particular, systems and methods of the present disclosure are directed to adjusting the gains of the grid-forming power regulator 204 in such a way that the power output of the wind turbine generator is less sensitive to changes in grid frequency/phase angle at lower speeds. In particular, FIG. 10 illustrates a flow diagram of an embodiment of a method 250 for constraining grid frequency support of a wind turbine connected to an electrical grid to prevent a trip event in the wind turbine is provided. In general, the method 250 is described herein with reference to the wind turbine 10 of FIGS. 2-9. However, it should be appreciated that the disclosed method 250 may be implemented with wind turbines having any other suitable configurations. In addition, although FIG. 10 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown at (252), the method 250 includes receiving, via a controller, one or more speed feedback signals from the wind turbine. For example, in an embodiment, the speed feedback signal(s) may include a rotor speed, a generator speed, a wind speed, or any other speed parameter of the wind turbine. As shown at (254), the method 250 includes adjusting, via the controller, one or more parameters of a power regulator of the wind turbine based on the one or more speed feedback signals such that a power output of the wind turbine is less sensitive to changes in at least one of grid frequency or phase angle. In an embodiment, for example, the parameter(s) of the power regulator 204 may include one or more gains of the power regulator 204. In particular, it is beneficial to be less sensitive to grid frequency drops or negative phase jumps when the amount of energy available to the wind turbine is low enough that the support of the grid frequency and/or phase cannot be maintained without tripping (e.g., on underspeed trip). The amount of energy available may be related to the energy input from the wind or the stored kinetic energy of the rotating system. The amount of energy available may be related to the energy input from the wind or the stored kinetic energy of the rotating system. The energy input from the wind may be closely related to a measured wind speed, and the stored energy kinetic energy may be closely related to a measured generator speed or a rotor speed.

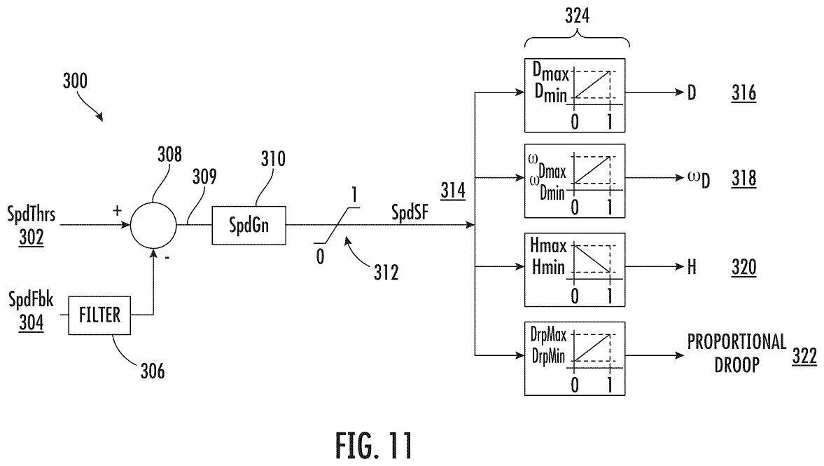

The method 250 of FIG. 10 can be better understood with reference to FIG. 11. In particular, FIG. 11 illustrates a schematic diagram of a system 300 for adjusting the gains of the power regulator 204 of the wind turbine 10 based on speed such that the power output of the wind turbine 10 is less sensitive to changes in the grid frequency and/or the phase angle. More specifically, as shown, the system 300 is configured to receive a speed threshold 302 (e.g., SpdThrs) and one or more speed feedback signals 304 (e.g., SpdFbk). In an embodiment, for example, the speed threshold 302 generally encompass a predetermined speed threshold below which the power regulator gains begin to be changed in a direction to reduce sensitivity to grid frequency/phase changes. Moreover, in an embodiment, the speed feedback signal(s) 304 generally encompasses speed feedback signals of the variable speed wind turbine 10, usually estimated based on sensor instrumentation (e.g., using a tachometer and/or an encoder).

Furthermore, as shown, the system 300 may include one or more filters 306 for filtering the one or more speed feedback signals from the wind turbine 10. Thus, as shown at 308, the system 300 is configured to compare the speed feedback signal(s) 304 from the wind turbine 10 to the speed threshold 302 to obtain a difference 309 between the speed feedback signal(s) 304 and the speed threshold 302. Moreover, when the speed feedback signal(s) 304 is less than the speed threshold 302, as shown at 310, the system 300 is configured to apply a predetermined parameter setting 310 (e.g., SpdGn) to the difference 309 to generate a speed dependent scale factor 314 (e.g., SpdSF). In such embodiments, the predetermined parameter setting determines a steepness of a relationship between speed and power regulator settings when SpdFbk<SpdThrs. In further embodiments, as shown, the system 300 may also be configured to limit the speed dependent scale factor 314, e.g., via limiter 312.

Accordingly, the speed dependent scale factor 314 is used in determining various power regulator settings. For example, in an embodiment, the system 300 is configured to determine the gains of the power regulator 204 using the speed dependent scale factor 314 and apply the gains to operation of the power regulator 204. In particular embodiments, as shown, the gain(s) of the power regulator 204 may include an inertia setting 320 of the power regulator 204 (e.g., parameter H in the inertial regulator 234 in FIG. 9), one or more damping parameters 316, 318 of the power regulator 204 (e.g., parameters ω_{D} and D in the inertial regulator 234 in FIG. 9), and/or a frequency droop/proportional droop 322 of the power regulator 204 (e.g., within the proportional droop control 228 of FIG. 9). Still other elements 324 of FIG. 11 further illustrate the linear relationship between the speed dependent scale factor 314 and the corresponding gain/parameter of the power regulator 204.

Further aspects of the invention are provided by the subject matter of the following clauses:

A method for constraining grid frequency support of a wind turbine connected to an electrical grid to prevent a trip event in the wind turbine, the method comprising: receiving, via a controller, one or more speed feedback signals from the wind turbine; and adjusting, via the controller, one or more parameters of a power regulator of the wind turbine based on the one or more speed feedback signals such that a power output of the wind turbine is less sensitive to changes in at least one of grid frequency or phase angle.

The method of any preceding clause, wherein the one or more speed feedback signals comprises at least one of a rotor speed, a generator speed, or a wind speed.

The method of any preceding clause, wherein the power regulator is a grid forming power regulator.

The method of any preceding clause, wherein the one or more parameters of the power regulator comprise one or more gains of the power regulator.

The method of any preceding clause, wherein the one or more gains of the power regulator comprise at least one of an inertia setting of the power regulator, one or more damping parameters of the power regulator, or a frequency droop parameter of the power regulator.

The method of any preceding clause, wherein adjusting the one or more parameters of the power regulator of the wind turbine depending on the one or more speed feedback signals such that the power output of the wind turbine is less sensitive to changes in at least one of the grid frequency or the phase angle further comprises: receiving, via the controller, a speed threshold; and comparing, via the controller, the one or more speed feedback signals from the wind turbine to the speed threshold to obtain a difference between the one or more speed feedback signals and the speed threshold.

The method of any preceding clause, wherein adjusting the one or more parameters of the power regulator of the wind turbine depending on the one or more speed feedback signals such that the power output of the wind turbine is less sensitive to changes in at least one of the grid frequency or the phase angle further comprises: when the one or more speed feedback signals is less than the speed threshold, applying, via the controller, a predetermined parameter setting to the difference to generate a speed dependent scale factor, the predetermined parameter setting determining a steepness of a relationship between speed and power regulator settings.

The method of any preceding clause, wherein adjusting the one or more parameters of the power regulator of the wind turbine depending on the one or more speed feedback signals such that the power output of the wind turbine is less sensitive to changes in at least one of the grid frequency or the phase angle further comprises: determining, via the controller, the one or more parameters of the power regulator using the speed dependent scale factor; and applying the one or more parameters to operation of the power regulator.

The method of any preceding clause, wherein adjusting the one or more parameters of the power regulator of the wind turbine depending on the one or more speed feedback signals such that the power output of the wind turbine is less sensitive to changes in at least one of the grid frequency or the phase angle further comprises: limiting, via a limiter of the controller, the speed dependent scale factor.

The method of any preceding clause, further comprising filtering, via a filter of the controller, the one or more speed feedback signals from the wind turbine.

A power regulator configured to constrain grid frequency support of a wind turbine connected to an electrical grid to prevent a trip event in the wind turbine, the power regulator comprising: a controller comprising at least one processor, the at least one processor configured to perform a plurality of operations, the plurality of operations comprising: receiving one or more speed feedback signals from the wind turbine; and adjusting one or more parameters of a power regulator of the wind turbine based on the one or more speed feedback signals such that a power output of the wind turbine is less sensitive to changes in at least one of grid frequency or phase angle.

The power regulator of any preceding clause, wherein the one or more speed feedback signals comprises at least one of a rotor speed, a generator speed, or a wind speed.

The power regulator of any preceding clause, wherein the power regulator is a grid forming power regulator.

The power regulator of any preceding clause, wherein the one or more parameters of the power regulator comprise one or more gains of the power regulator.

The power regulator of any preceding clause, wherein the one or more gains of the power regulator comprise at least one of an inertia setting of the power regulator, one or more damping parameters of the power regulator, or a frequency droop parameter.

The power regulator of any preceding clause, wherein adjusting the one or more parameters of the power regulator of the wind turbine depending on the one or more speed feedback signals such that the power output of the wind turbine is less sensitive to changes in at least one of the grid frequency or the phase angle further comprises: receiving a speed threshold; and comparing the one or more speed feedback signals from the wind turbine to the speed threshold to obtain a difference between the one or more speed feedback signals and the speed threshold.

The power regulator of any preceding clause, wherein adjusting the one or more parameters of the power regulator of the wind turbine depending on the one or more speed feedback signals such that the power output of the wind turbine is less sensitive to changes in at least one of the grid frequency or the phase angle further comprises: when the one or more speed feedback signals is less than the speed threshold, applying a predetermined parameter setting to the difference to generate a speed dependent scale factor, the predetermined parameter setting determining a steepness of a relationship between speed and power regulator settings.

The power regulator of any preceding clause, wherein adjusting the one or more parameters of the power regulator of the wind turbine depending on the one or more speed feedback signals such that the power output of the wind turbine is less sensitive to changes in at least one of the grid frequency or the phase angle further comprises: determining the one or more parameters of the power regulator using the speed dependent scale factor; and applying the one or more parameters to operation of the power regulator.

The power regulator of any preceding clause, wherein adjusting the one or more parameters of the power regulator of the wind turbine depending on the one or more speed feedback signals such that the power output of the wind turbine is less sensitive to changes in at least one of the grid frequency or the phase angle further comprises: limiting the speed dependent scale factor.

The power regulator of any preceding clause, further comprising filtering the one or more speed feedback signals from the wind turbine.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for constraining grid frequency support of a wind turbine connected to an electrical grid to prevent a trip event in the wind turbine, the method comprising:
receiving, via a controller, one or more speed feedback signals from the wind turbine; and
adjusting, via the controller, one or more parameters of a power regulator of the wind turbine based on the one or more speed feedback signals such that a power output of the wind turbine is less sensitive to changes in at least one of grid frequency or phase angle.

2. The method of claim 1, wherein the one or more speed feedback signals comprises at least one of a rotor speed, a generator speed, or a wind speed.

3. The method of claim 1, wherein the power regulator is a grid forming power regulator.

4. The method of claim 1, wherein the one or more parameters of the power regulator comprise one or more gains of the power regulator.

5. The method of claim 4, wherein the one or more gains of the power regulator comprise at least one of an inertia setting of the power regulator, one or more damping parameters of the power regulator, or a frequency droop parameter of the power regulator.

6. The method of claim 1, wherein adjusting the one or more parameters of the power regulator of the wind turbine depending on the one or more speed feedback signals such that the power output of the wind turbine is less sensitive to changes in at least one of the grid frequency or the phase angle further comprises:
receiving, via the controller, a speed threshold; and
comparing, via the controller, the one or more speed feedback signals from the wind turbine to the speed threshold to obtain a difference between the one or more speed feedback signals and the speed threshold.

7. The method of claim 6, wherein adjusting the one or more parameters of the power regulator of the wind turbine depending on the one or more speed feedback signals such that the power output of the wind turbine is less sensitive to changes in at least one of the grid frequency or the phase angle further comprises:
when the one or more speed feedback signals is less than the speed threshold, applying, via the controller, a predetermined parameter setting to the difference to generate a speed dependent scale factor, the predetermined parameter setting determining a steepness of a relationship between speed and power regulator settings.

8. The method of claim 7, wherein adjusting the one or more parameters of the power regulator of the wind turbine depending on the one or more speed feedback signals such that the power output of the wind turbine is less sensitive to changes in at least one of the grid frequency or the phase angle further comprises:
determining, via the controller, the one or more parameters of the power regulator using the speed dependent scale factor; and
applying the one or more parameters to operation of the power regulator.

9. The method of claim 8, wherein adjusting the one or more parameters of the power regulator of the wind turbine depending on the one or more speed feedback signals such that the power output of the wind turbine is less sensitive to changes in at least one of the grid frequency or the phase angle further comprises:
limiting, via a limiter of the controller, the speed dependent scale factor.

10. The method of claim 1, further comprising filtering, via a filter of the controller, the one or more speed feedback signals from the wind turbine.

11. A power regulator configured to constrain grid frequency support of a wind turbine connected to an electrical grid to prevent a trip event in the wind turbine, the power regulator comprising:
a controller comprising at least one processor, the at least one processor configured to perform a plurality of operations, the plurality of operations comprising:
receiving one or more speed feedback signals from the wind turbine;
and
adjusting one or more parameters of a power regulator of the wind turbine based on the one or more speed feedback signals such that a power output of the wind turbine is less sensitive to changes in at least one of grid frequency or phase angle.

12. The power regulator of claim 11, wherein the one or more speed feedback signals comprises at least one of a rotor speed, a generator speed, or a wind speed.

13. The power regulator of claim 11, wherein the power regulator is a grid forming power regulator.

14. The power regulator of claim 11, wherein the one or more parameters of the power regulator comprise one or more gains of the power regulator.

15. The power regulator of claim 14, wherein the one or more gains of the power regulator comprise at least one of an inertia setting of the power regulator, one or more damping parameters of the power regulator, or a frequency droop parameter.

16. The power regulator of claim 11, wherein adjusting the one or more parameters of the power regulator of the wind turbine depending on the one or more speed feedback signals such that the power output of the wind turbine is less sensitive to changes in at least one of the grid frequency or the phase angle further comprises:
receiving a speed threshold; and
comparing the one or more speed feedback signals from the wind turbine to the speed threshold to obtain a difference between the one or more speed feedback signals and the speed threshold.

17. The power regulator of claim 16, wherein adjusting the one or more parameters of the power regulator of the wind turbine depending on the one or more speed feedback signals such that the power output of the wind turbine is less sensitive to changes in at least one of the grid frequency or the phase angle further comprises:
when the one or more speed feedback signals is less than the speed threshold, applying a predetermined parameter setting to the difference to generate a speed dependent scale factor, the predetermined parameter setting determining a steepness of a relationship between speed and power regulator settings.

18. The power regulator of claim 17, wherein adjusting the one or more parameters of the power regulator of the wind turbine depending on the one or more speed feedback signals such that the power output of the wind turbine is less sensitive to changes in at least one of the grid frequency or the phase angle further comprises:
determining the one or more parameters of the power regulator using the speed dependent scale factor; and
applying the one or more parameters to operation of the power regulator.

19. The power regulator of claim 18, wherein adjusting the one or more parameters of the power regulator of the wind turbine depending on the one or more speed feedback signals such that the power output of the wind turbine is less sensitive to changes in at least one of the grid frequency or the phase angle further comprises:
limiting the speed dependent scale factor.

20. The power regulator of claim 11, further comprising filtering the one or more speed feedback signals from the wind turbine.
